(19) United States
(12) Patent Application Publication
(10) Pub. No.: US 2016/0048811 A1
(43) Pub. Date: Feb. 18, 2016

(54) DIAGNOSTIC INQUIRY DEVICE AND DIAGNOSTIC INQUIRY METHOD

(71) Applicant: HONDA MOTOR CO., LTD., Tokyo (JP)

(72) Inventors: Keiji ASAI, Kawagoe-shi, Saitama-ken (JP); Makoto KANAI, Shimotsuke-shi, Tochigi-ken (JP); Takeshi YOSHIDA, Kawagoe-shi, Saitama-ken (JP)

(21) Appl. No.: 14/779,671

(22) PCT Filed: Feb. 20, 2014
(86) PCT No.: PCT/JP2014/054050

§ 371 Date: Sep. 24, 2015

(30) Foreign Application Priority Data
Mar. 28, 2013 (JP) 2013-069407

(51) Int. Cl. G06Q 10/00; G07C 5/12; G07C 5/08; G06Q 30/02; G07C 5/00

(52) U.S. Cl. CPC G06Q 10/20; G06Q 30/0281; G07C 5/006; G07C 5/008; G07C 5/0808; G07C 5/0825; G07C 5/0833; G07C 5/12; G07C 5/085

(57) ABSTRACT

In this diagnostic inquiry device and diagnostic inquiry method, types of abnormal sound that are or that accompany malfunction symptoms are included among options for obtaining information pertaining to malfunction symptoms. When the contents of malfunction symptoms are related to the occurrence of an abnormal sound in a device that is the subject of diagnosis, a control unit outputs from a sample abnormal sound output unit a sample abnormal sound that is on the basis of a plurality of types of sample abnormal sound data stored in an external server or a storage unit of the diagnostic inquiry device.

### TECHNICAL FIELD

The present invention relates to a diagnostic inquiry device and a diagnostic inquiry method which are used for a diagnostic inquiry for estimating the cause of a malfunction symptom, in diagnosis of an apparatus such as a vehicle or the like in which the malfunction symptom occurs.

### BACKGROUND ART

In the case that some type of malfunction symptom (abnormal event) occurs in an automobile, typically, a customer who is the owner of the automobile makes a request for an inspection or maintenance to a sales office such as a dealership where the automobile was purchased. In addition, based on such a request, a person in charge of maintenance checks the location of the malfunction and then carries out an inspection or maintenance.

Upon performing such an inspection or maintenance, when the request for inspection or maintenance is accepted, a diagnostic inquiry result acquired from the customer concerning the malfunction symptom and one or more trouble codes (DTC) that are stored in an electronic control unit (ECU) in the vehicle are treated as vitally important reference data.

In order to elicit a correct answer by asking the customer concerning the malfunction symptom, expert knowledge concerning the content to be questioned is required. Therefore, compared to being handled by a person in charge of maintenance who possesses deep expert knowledge, with handling by a reception desk, or handling by service personnel that are met upon picking up the vehicle, etc., cases can be assumed in which the inquiries made to the customer are insufficient.

Further, in the case of a customer who is not deeply informed about the vehicle, situations can also be assumed in which answers are given in a doubtful or insecure state of mind, in a condition where sufficient understanding of the content of the inquiries cannot be achieved.

A conventional technology that relates to this type of diagnostic inquiry is disclosed in U.S. Patent Application Publication No. 2003/0225790 (hereinafter referred to as US2003/0225790A1). According to US2003/0225790A1, an inquiry database 21 in which failure information is stored in association with multiple answers to each of inquiry questions is created beforehand on the side of a vehicle inquiry apparatus 3 (server) (see FIGS. 1 and 2). A vehicle model 31, an inquiry result 32, the cause of a failure 33, and repair content 34 are stored in the inquiry database 21 (see FIG. 3 and paragraph [0065]).

In addition, in a situation in which an actual diagnostic inquiry is carried out, an inquiry person or checker 17 inquires, from a customer 15, a malfunction symptom of a vehicle 14, and inputs the malfunction symptom into a checker PDA 9. The checker PDA 9 then transmits to the vehicle inquiry apparatus 3 vehicle information of the vehicle 14 and the malfunction symptom, and requests questions to be asked for the purpose of the diagnostic inquiry (step S2 of FIG. 4, paragraph [0070]).

Based on the vehicle information and the symptom that were received, the vehicle inquiry apparatus 3 creates inquiries 41 (step S3) and transmits the inquiries 41 back to the checker PDA 9 (step S4). The checker 17 asks the customer the inquiries 41 that were received by the checker PDA 9, and inputs the responses 42 thereto to the checker PDA 9 (step S5). The checker PDA 9 then transmits the input responses 42 to the vehicle inquiry apparatus 3 (step S6) (see paragraph [0071]). As needed, the steps of making the inquiries 41 and receiving the responses 42 thereto are repeated (see paragraph [0072]).

### SUMMARY OF INVENTION

In the foregoing manner, according to US2003/0225790A1, the malfunction symptom input to the checker PDA 9 as a result of the checker 17 listening to the comments from the customer 15 are transmitted to the vehicle inquiry apparatus 3, whereupon the vehicle inquiry apparatus 3 creates the inquiries 41 for carrying out a fault diagnosis based on the malfunction symptom.

The vehicle inquiry apparatus 3 disclosed in US2003/0225790A1 serves as a tool for creating inquiries 41 to perform a fault diagnosis. However, when the checker 17 asks the customer 15 in order to confirm the symptom itself at a stage prior to diagnosis, there is a possibility that the skill of the checker 17 in listening to and acquiring the malfunction symptom from the customer 15 will impart a large influence on the diagnostic operation.

In the case that such inquiries are carried out directly by a person in charge of maintenance who performs the fault diagnosis, depending on the customer, inquiries are repeated utilizing extensive experience and knowledge, and the malfunction symptom can be grasped appropriately. However, in the case that only the results of inquiries are received, speaking from the standpoint of the person in charge of maintenance, if the inquiries are not made appropriately, it is not possible to obtain correct information for grasping the malfunction symptom, and further, speaking from the standpoint of the customer, it is possible that a sense of satisfaction cannot be fulfilled in fully conveying information that the customer himself has noticed, or in having the spoken content from the customer listened to sufficiently.

The present invention has been devised while taking into consideration the aforementioned problems, and has the object of providing a diagnostic inquiry device and a diagnostic inquiry method, in which by setting diagnostic inquiry items that are easy to understood and that are simple to answer, it is possible to accurately confirm a malfunction symptom or to enhance customer satisfaction.

A diagnostic inquiry device according to the present invention carries out a diagnostic inquiry for acquiring related information related to a malfunction symptom that occurs in a diagnostic target vehicle, and based on the acquired information, estimates the cause of the malfunction symptom on its own or externally outputs the acquired information. The diagnostic inquiry device includes a display unit configured to display questions for acquiring the related information, a sample abnormal sound outputting unit configured to output sample abnormal sounds corresponding to malfunction symptoms, a controller configured to control display of the display unit and output of sounds from the sample abnormal sound outputting unit, and process an operation input from a user, and a storage unit configured to store display data and sample abnormal sound data, is the display data being data related to displays of the display unit, the sample abnormal sound data being data related to the sample abnormal sounds. The controller displays on the display unit a plurality of situation selection buttons and a plurality of symptom selection buttons, the situation selection buttons serving as selection buttons for determining selection of a driving operation situation in which the malfunction symptom occurs, the symptom selection buttons serving as selection buttons for determining selection of content of the malfunction symptom, the content being associated with the selection result of the situation selection buttons. Further, in the case that the content of the malfunction symptom relates to abnormal sounds generated by the diagnostic target vehicle, the controller displays sample abnormal sound output buttons on the display unit alongside the symptom selection buttons, the sample abnormal sound output buttons causing the sample abnormal sounds corresponding to the malfunction symptom to be output.

According to the present invention, since selection of driving operation situations in which malfunction symptoms occur is used as inquiry items, an inquiry scheme to which the customer easily responds can be provided.

Further, after a driving operation situation in which the malfunction symptom occurs has been selected, the selection of content for the malfunction symptom, which is associated with the selected driving operation situation, is requested. For this reason, it is possible to narrow down content for the malfunction symptom responsive to the driving operation situation, and the number of necessary inquiry items can be reduced.

Furthermore, in the event that the content of the malfunction symptom is associated with generation of an abnormal sound, a corresponding sample abnormal sound can be output as an indicator for selecting the symptom. Therefore, by comparing the abnormal sound with a plurality of sample abnormal sounds, a person who has actually heard the abnormal sound (for example, a customer) can easily select and respond to the symptom content of an abnormal sound occurrence that may be difficult to express verbally.

The sample abnormal sound data can be data for which vehicle sounds are collected, wherein the vehicle sounds are generated responsive to the respective malfunction symptoms. Consequently, since actual vehicle sounds are compared with respect to the abnormal sound, confirmation of the content of the malfunction symptom is easily carried out, based on minute differences in the abnormal sounds for which judgment may be difficult.

In the case that a malfunction symptom in which the abnormal sound is generated has been selected by the symptom selection buttons, the controller may display vehicle drawings on the display unit, wherein an estimated location of the generating source of the abnormal sound can be input on the vehicle drawings by an operation input from the user, and may accept the operation input from the user as the estimated location of the generating source of the abnormal sound. Thus, a user of the diagnostic inquiry device or a person who has actually heard the abnormal sound can select or input an estimated position intuitively and as actually felt.

The storage unit may associate and store in a tree structure the situation selection buttons and the symptom selection buttons, and the controller may switch screens for each of the situation selection buttons and the symptom selection buttons, and may display the screens on the display unit.

According to this feature, by associating the situation selection buttons and the symptom selection buttons in a tree structure, the content of the questions can be organized systematically, and the ordering of the questions can be presented in a natural and easily understood manner. Therefore, for the customer to whom the diagnostic inquiries are made, content that the customer himself wishes to convey can be conveyed adequately, and the customer's satisfaction can be enhanced.

The controller may display the situation selection buttons, the symptom selection buttons, and the sample abnormal sound output buttons in the form of illustrations on a touch panel. Consequently, the operation screen is easily viewed, and through the displayed illustrations, grasping of the inquiry content and the operation to select such inquiry content can be simplified.

A diagnostic inquiry method for confirming, with a customer, a malfunction symptom of a diagnostic target vehicle through a diagnostic inquiry, is characterized by the steps of displaying on a display unit a plurality of situation selection buttons and a plurality of symptom selection buttons, the situation selection buttons being selection buttons for determining selection of a driving operation situation in which the malfunction symptom occurs, the symptom selection buttons being selection buttons for determining selection of content of the malfunction symptom, that the content being associated with the selection result of the situation selection buttons, and further, in the case that the content of the malfunction symptom relates to an abnormal sound generated by the diagnostic target vehicle, displaying on the display unit sample abnormal sound output buttons alongside the symptom selection buttons, the sample abnormal sound output buttons causing sample abnormal sounds corresponding to the malfunction symptoms to be output.

A diagnostic inquiry device carries out a diagnostic inquiry for acquiring related information related to an abnormal event that occurs in a diagnostic target device, and based on the acquired information, estimates the cause of the abnormal event on its own or externally outputs the acquired information. The diagnostic inquiry device includes an option presentation unit configured to present, as sounds or images, options for acquiring the related information, a sample abnormal sound outputting unit configured to output sample abnormal sounds corresponding to abnormal events, and a controller configured to control presentation of the options by the option presentation unit and output of sounds from the sample abnormal sound outputting unit, and process a selection input from a user. In the case that the content of the abnormal event relates to an abnormal sound generated by the diagnostic target device, the controller outputs the sample abnormal sounds from the sample abnormal sound outputting unit, responsive to a selection input of the options, the sample abnormal sounds being based on multiple types of sample abnormal sound data that are stored in an external server or in a storage unit of the diagnostic inquiry device.

According to the present invention, in the event that the content of the abnormal event is associated with generation of an abnormal sound, a corresponding sample abnormal sound can be output as an indicator for selecting the symptom. Therefore, by comparing the abnormal sound with a plurality of sample abnormal sounds, a person who actually experienced the abnormal sound (for example, a customer) can easily select and respond to the symptom content of an abnormal sound occurrence that may be difficult to express verbally.

### BRIEF DESCRIPTION OF DRAWINGS

FIG. 1 is a view showing a general configuration of a vehicle diagnostic system in which a diagnostic inquiry device according to an embodiment of the present invention is included;

FIG. 2 is a flowchart showing an example of behaviors of a customer, a person in charge of service, and a person in charge of maintenance, in the case that a malfunction symptom has occurred in a vehicle;

FIG. 3 is a flowchart showing processes of a diagnostic inquiry device when a diagnostic inquiry is carried out;

FIG. 4 is a view showing the content of a diagnostic inquiry being managed in a tree structure according to the aforementioned embodiment;

FIG. 5 is a view showing a first display screen when a diagnostic inquiry is carried out in the aforementioned embodiment;

FIG. 6 is a view showing a second display screen when a diagnostic inquiry is carried out in the aforementioned embodiment;

FIG. 7 is a view showing a third display screen when a diagnostic inquiry is carried out in the aforementioned embodiment;

FIG. 8 is a view showing a fourth display screen when a diagnostic inquiry is carried out in the aforementioned embodiment;

FIG. 9 is a view showing a fifth display screen when a diagnostic inquiry is carried out in the aforementioned embodiment;

FIG. 10 is a view showing a sixth display screen when a diagnostic inquiry is carried out in the aforementioned embodiment;

FIG. 11 is a view showing a seventh display screen when a diagnostic inquiry is carried out in the aforementioned embodiment;

FIG. 12 is a view showing an eighth display screen when a diagnostic inquiry is carried out in the aforementioned embodiment;

FIG. 13 is a view showing a ninth display screen when a diagnostic inquiry is carried out in the aforementioned embodiment;

FIG. 14 is a view showing a tenth display screen when a diagnostic inquiry is carried out in the aforementioned embodiment;

FIG. 15 is a view showing an eleventh display screen when a diagnostic inquiry is carried out in the aforementioned embodiment;

FIG. 16 is a view showing a twelfth display screen when a diagnostic inquiry is carried out in the aforementioned embodiment;

FIG. 17 is a view showing a thirteenth display screen when a diagnostic inquiry is carried out in the aforementioned embodiment;

FIG. 18 is a view showing a fourteenth display screen when a diagnostic inquiry is carried out in the aforementioned embodiment;

FIG. 19 is a view showing a fifteenth display screen when a diagnostic inquiry is carried out in the aforementioned embodiment;

FIG. 20 is a view showing a sixteenth display screen when a diagnostic inquiry is carried out in the aforementioned embodiment;

FIG. 21 is a view showing a seventeenth display screen when a diagnostic inquiry is carried out in the aforementioned embodiment; and

FIG. 22 is a view showing a printed example of diagnostic inquiry results according to the aforementioned embodiment.

### DESCRIPTION OF EMBODIMENTS

### A. Embodiment

### 1. Configuration

### 1-1. Overall Configuration

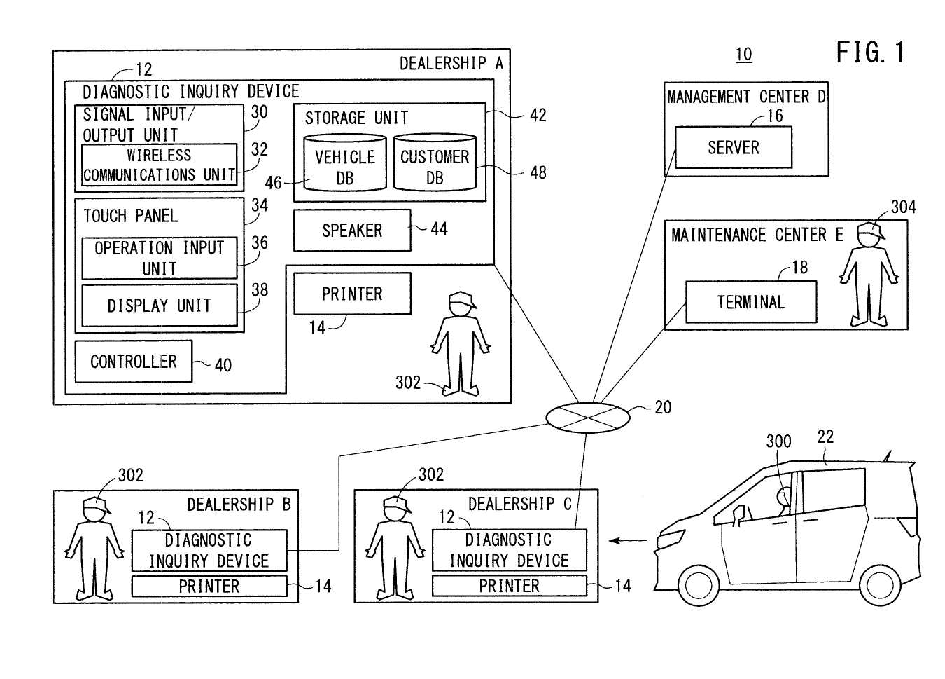

FIG. 1 is a view showing a general configuration of a vehicle diagnostic system 10 (hereinafter also referred to as a “system 10”) in which a diagnostic inquiry device 12 according to an embodiment of the present invention is included. The system 10 is equipped with diagnostic inquiry devices 12 and printers 14 that are arranged in a plurality of vehicle dealerships A to C (hereinafter also referred to as “dealerships A to C”) as service centers, a management server 16 (hereinafter also referred to as a “server 16”) that is arranged in a management center D, and a maintenance center terminal 18 (hereinafter also referred to as a “terminal 18”) that is arranged in a maintenance center E. In the present embodiment, the respective diagnostic inquiry devices 12, the server 16, and the maintenance center terminal 18 are capable of communicating through a communications network 20.

### 1-2. Diagnostic Inquiry Device 12

The diagnostic inquiry devices 12, which are arranged in the dealerships, carry out diagnostic inquiries for acquiring related information of malfunction symptoms (abnormal events) that occur in vehicles 22 that serve as diagnostic target vehicles or diagnostic target devices. Additionally, based on the acquired related information (acquired information), the diagnostic inquiry devices 12 estimate the cause of malfunction symptoms on their own or externally output the acquired information.

As shown in FIG. 1, each of the diagnostic inquiry devices 12 includes a signal input/output unit 30 (hereinafter referred to as an “input/output unit 30”) including a wireless communications unit 32, a touch panel 34 having an operation input unit 36 and a display unit 38 (option presentation unit), a controller 40 (arithmetic processor), a storage unit 42, and a speaker 44. As a hardware configuration for the diagnostic inquiry device 12, there can be used, for example, a commercially available tablet computer or a smart phone. Alternatively, the diagnostic inquiry device 12 may be a notebook or desktop personal computer. Although in FIG. 1, the internal configuration of only the diagnostic inquiry device 12 of the dealership A is shown, the diagnostic inquiry devices of the dealerships B and C are of the same configuration.

The input/output unit 30 carries out input and output of signals via communication lines between the diagnostic inquiry device 12 and external apparatus (e.g., the server 16 of the management center D, the terminal 18 of the maintenance center E). The wireless communications unit 32 is an interface for performing input and output of signals wirelessly.

Through the operation input unit 36 in the touch panel 34, a person in charge of service 302 as a user who operates the diagnostic inquiry device 12 carries out input operations concerning items responsive to the content while listening to the opinions and observations of a customer 300. The display unit 38 displays a screen (diagnostic inquiry screen) for facilitating the diagnostic inquiry. As will be described later, instead of using the touch panel 34, it is possible to adopt a configuration in which the operation input unit 36 and the display unit 38 are provided separately (for example, a personal computer having a display as the display unit 38, and a mouse and keyboard that serve as the operation input unit 36).

The controller 40 executes various processes by controlling the respective components of the diagnostic inquiry device 12. The controller 40 of the present embodiment executes a diagnostic inquiry process in order to acquire related information for estimating the cause of the malfunction symptoms (abnormal events) that occur in the vehicles 22. Further, based on the acquired information, the controller 40 estimates the cause of the malfunction symptoms on its own or externally outputs the acquired information (to the server 16, the terminal 18, etc.) through the signal input/output unit 30.

The storage unit 42 stores various programs and data such as control programs, etc., used by the controller 40. As examples of such data, the details of which will be described later, there are included display data, which is data in relation to the display of the touch panel 34 (display unit 38), and sample abnormal sound data, which is data in relation to samples of abnormal sounds (hereinafter referred to as “sample abnormal sounds”). Further, the storage unit 42 is equipped with a vehicle database 46 (hereinafter referred to as a “vehicle DB 46”) and a customer database 48 (hereinafter referred to as a “customer DB 48”).

Among the information stored in the vehicle DB 46, there are included the vehicle identification number (hereinafter also referred to as “VIN”), the license plate number, and the vehicle model, etc. In the customer DB 48, there is included information in relation to the customer 300 (user of the vehicle 22). As information concerning the customer 300, there may be included, for example, the name, gender, date of birth (age), family structure, and purpose for use of the vehicle.

The speaker 44 (sample abnormal sound outputting unit) is capable of outputting various sounds. In the present embodiment, outputting of sample abnormal sounds as malfunction symptoms or of sample abnormal sounds accompanying the malfunction symptoms is carried out.

### 1-3. Management Server 16

The server 16 serves to manage the system 10 in its entirety. The server 16 collects and centrally manages diagnostic inquiry data (related information of malfunction symptoms) from the diagnostic inquiry devices 12 of the respective dealerships A to C, and transmits maintenance or inspection requests from the respective diagnostic inquiry devices 12 to the maintenance center terminal 18. The server 16, in the same manner as the diagnostic inquiry devices 12, is equipped with a signal input/output unit, an operation input unit, a display unit, a controller, a storage unit, and a speaker (none of which are shown).

### 1-4. Maintenance Center Terminal 18

The maintenance center terminal 18, in the same manner as the diagnostic inquiry devices 12 and the management server 16, is equipped with a signal input/output unit, an operation input unit, a display unit, a controller, a storage unit, and a speaker (none of which are shown). Repair requests from the diagnostic inquiry devices 12 are transmitted to the terminal 18 through the management server 16, and such requests are displayed on a non-illustrated display unit.

### 2. Process Flow upon the Occurrence of a Malfunction Symptom

### 2-1. Behaviors of Customer 300, Person in Charge of Service 302, and Person in Charge of Maintenance 304

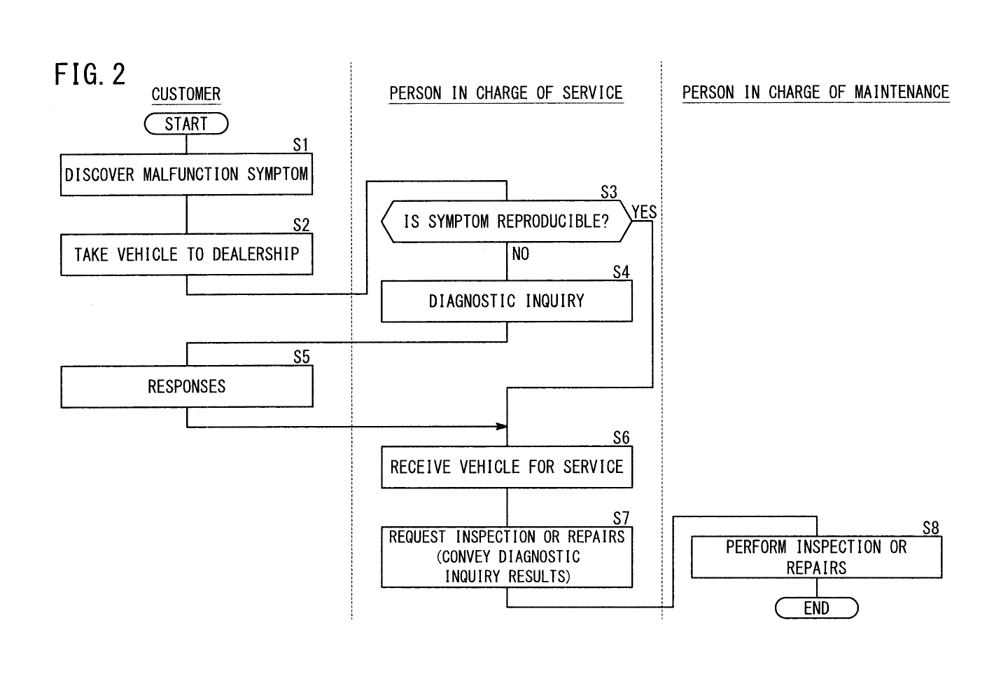

FIG. 2 is a flowchart showing an example of behaviors of a customer 300, a person in charge of service 302, and a person in charge of maintenance 304, in the case that a malfunction symptom has occurred in the vehicle 22. In step S1, the customer 300 (user of the vehicle 22) discovers a malfunction symptom in the vehicle 22. Then, the customer 300 takes the vehicle 22 to one of the dealerships A to C (for example, the dealership C) for the purpose of consultation to remedy the malfunction symptom, and requests that an inspection or repairs be performed to a member of the dealership staff such as a person in charge of service 302 or the like (step S2).

In step S3, the person in charge of service 302 of the dealership C confirms whether or not the malfunction symptom, for which consultation was requested, can actually be reproduced in the vehicle 22 that was taken to the dealership. If the malfunction symptom is reproducible (step S3: YES), then it is judged that an inspection of the vehicle 22 is needed, and the vehicle 22 is received for service at the dealership (step S6).

If the malfunction symptom is not reproducible (step S3: NO), then in step S4, the person in charge of service 302 carries out a diagnostic inquiry with respect to the customer 300 concerning the malfunction symptom that occurred. Then, after responses have been received from the customer 300 in step S5, the vehicle 22 is received for service at the dealership (step S6).

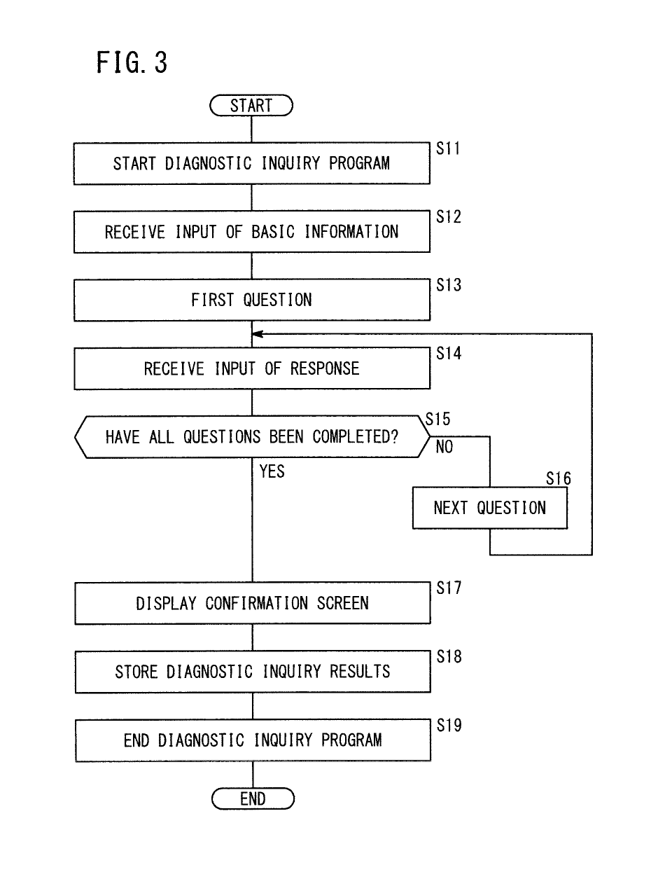

In step S7, the person in charge of service 302 makes a request for an inspection or repairs to be performed on the vehicle 22 that was received from the customer 300, with respect to a person in charge of maintenance 304 in the maintenance and repairs department. At this time, if the malfunction symptom is reproducible, detailed content thereof is conveyed to the person in charge of maintenance 304, whereas if the malfunction symptom is not reproducible, the diagnostic inquiry results of the customer 300 are conveyed to the person in charge of maintenance 304. Concerning the method by which the diagnostic inquiry results are conveyed, a method can be adopted such as handing over printed matter of the diagnostic inquiry results, or sending by email data of the diagnostic inquiry results (further details will be described later with reference to FIG. 3, etc.).

In step S8, the person in charge of maintenance 304 carries out an inspection or makes repairs on the vehicle 22, based on trouble codes stored in the vehicle 22 and information of the diagnostic inquiry results, etc., received from the person in charge of service 302.

### 2-2. Outline of Processes of the Diagnostic Inquiry Device 12 during the Diagnostic Inquiry

FIG. 3 is a flowchart showing processes of the diagnostic inquiry device 12 when a diagnostic inquiry is carried out. The following processes are carried out by the controller 40 of the diagnostic inquiry device 12 executing a diagnostic inquiry program that is stored in the storage unit 42. Further, as noted above, according to the present embodiment (FIG. 2), the person in charge of service 302 operates the diagnostic inquiry device 12 when diagnostic inquiries are made with respect to the customer 300. For this reason, the description given below is premised on a situation in which a diagnostic inquiry is made to the customer 300 while the person in charge of service 302 operates the diagnostic inquiry device 12. However, the method of use of the diagnostic inquiry device 12 is not limited to the above, and the diagnostic inquiry device 12 may be operated by the customer 300 himself. Alternatively, the person in charge of maintenance 304 can use the diagnostic inquiry device 12 for confirming the malfunction symptom of the vehicle 22.

In step S11 of FIG. 3, the diagnostic inquiry program of the diagnostic inquiry device 12 is initiated by an operation made by the person in charge of service 302 (user of the diagnostic inquiry device 12). The diagnostic inquiry program is stored in the storage unit 42.

When the diagnostic inquiry program is started, the controller 40 of the diagnostic inquiry device 12 displays on the touch panel 34 an input screen (not shown) of basic information relating to the vehicle 22. As the above-mentioned basic information, there can be included, for example, at least one of a vehicle identification number (VIN) and a license plate number. The user (person in charge of service 302) who has observed the aforementioned input screen operates the touch panel 34 to input the basic information (step S12).

In steps S13 to S16, the controller 40 carries out an actual diagnostic inquiry. More specifically, in step S13, the controller 40 presents a first question. In step S14, the controller 40 accepts the input of an answer from the user (person in charge of service 302) through the touch panel 34. Stated otherwise, the person in charge of service 302 reads out to the customer 300 the first question that is displayed on the display unit 38 of the touch panel 34, and enters the response obtained from the customer 300 into the operation input unit 36 of the touch panel 34.

In step S15, the controller 40 determines whether or not all of the questions have been completed. If a portion of the questions have not been completed (step S15: NO), then in step S16, the controller 40 reads out the next question from the storage unit 42 and displays the question on the touch panel 34, whereupon the process flow returns to step S14. Steps S14 to S16 are repeated until all of the questions have ended. As will be described later, among the questions that are presented, there are included questions intended to specify a type of abnormal sound.

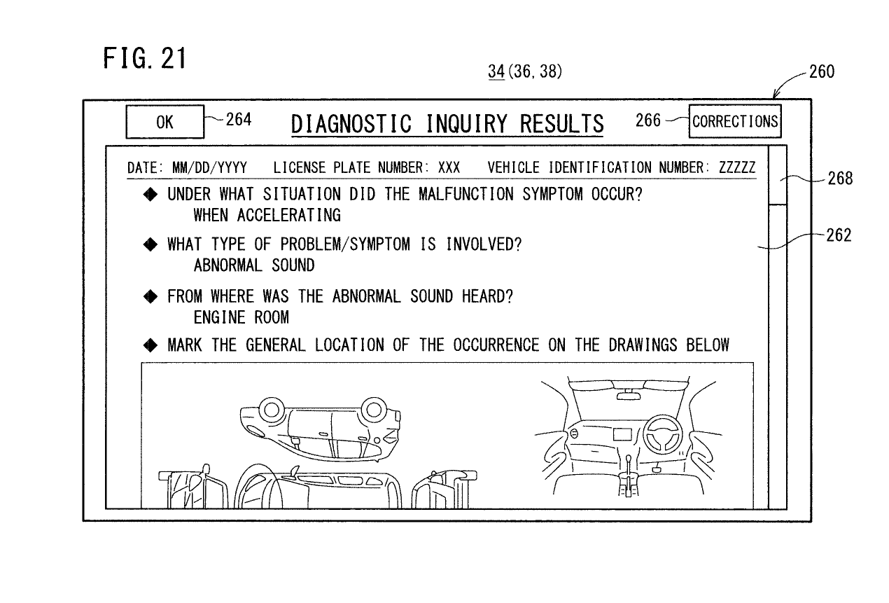

If all of the questions have ended (step S15: YES), then in step S17, the controller 40 displays on the touch panel 34 an input confirmation screen 260 (see FIG. 21) for confirming the diagnostic inquiry results. As will be described later, if there are points requiring correction in the displayed content of the input confirmation screen 260, corrections thereto can also be made.

Next, in step S18, responsive to an operation of the person in charge of service 302, the controller 40 stores the diagnostic inquiry results in the storage unit 42. Alternatively, in addition to or in place of storing the diagnostic inquiry results in the storage unit 42, the diagnostic inquiry results may be transmitted to at least one of the server 16 and the terminal 18.

In step S19, the controller 40 terminates the diagnostic inquiry program responsive to an operation of the person in charge of service 302.

### 2-3. Details of Processes of the Diagnostic Inquiry Device 12 during the Diagnostic Inquiry

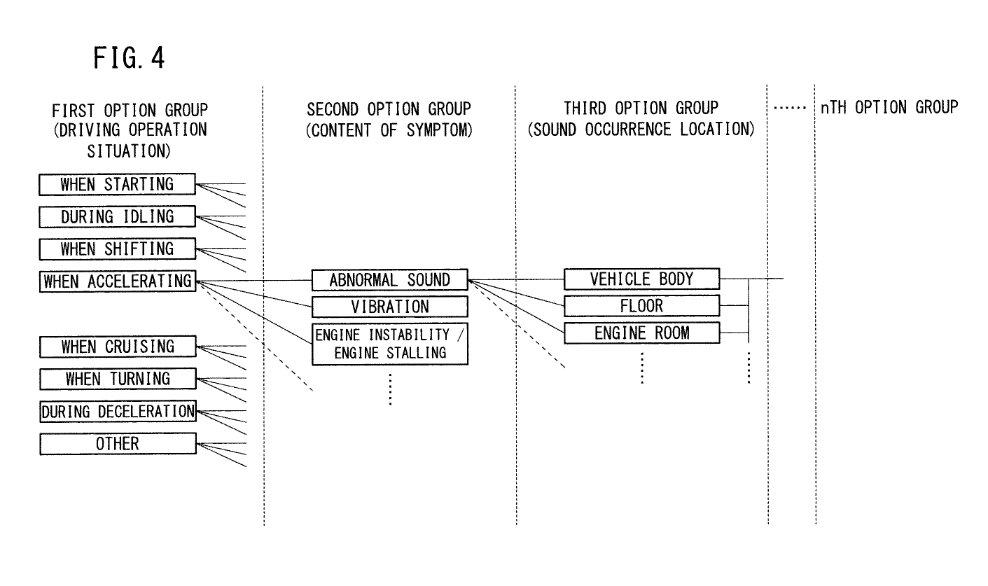

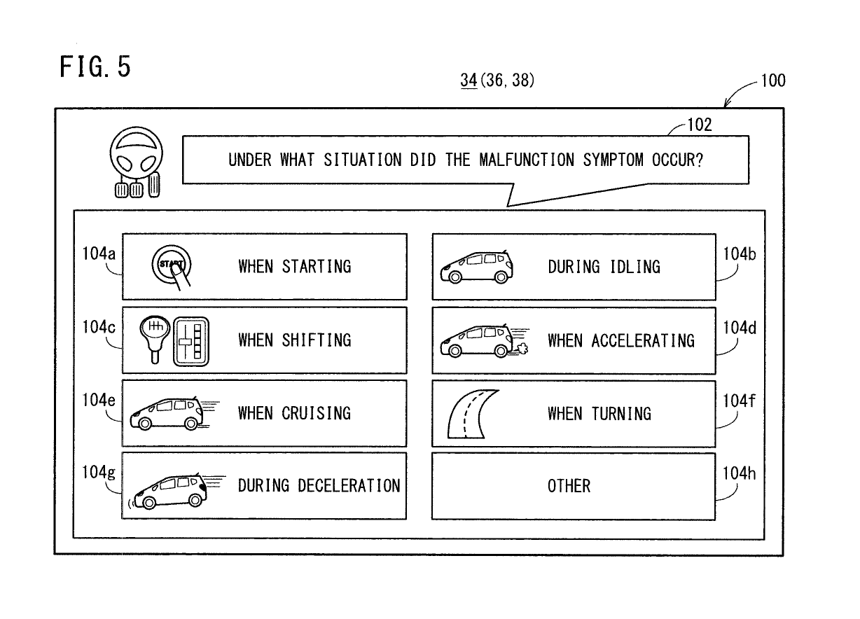

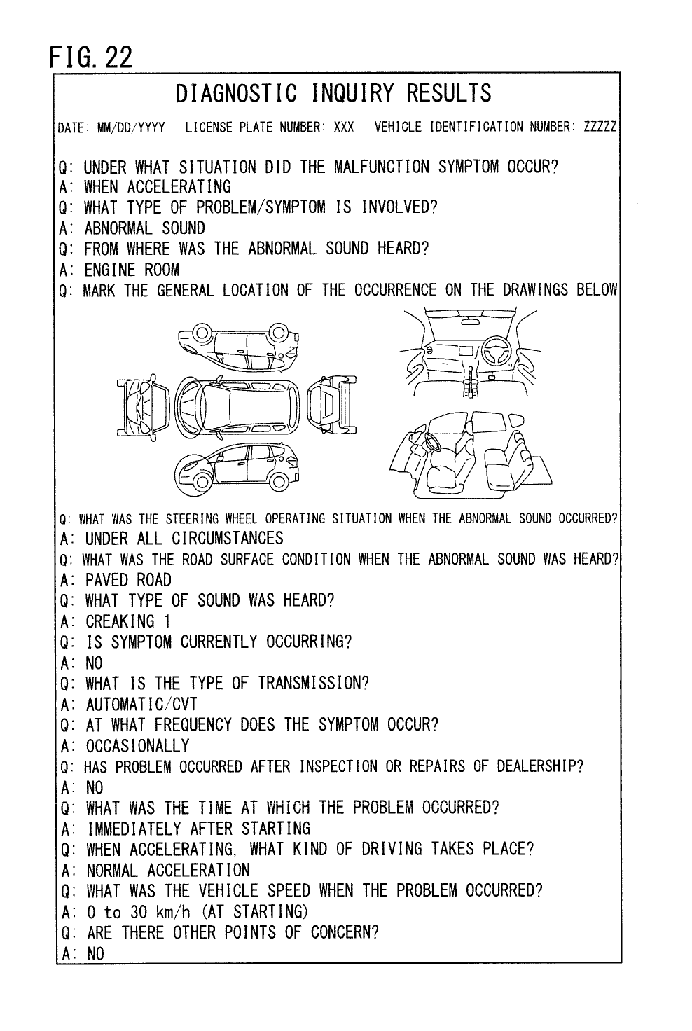

FIG. 4 is a view showing the content of diagnostic inquiries as managed in a tree structure according to the present embodiment. FIGS. 5 to 21 are views showing first through seventeenth display screens displayed when diagnostic inquiries are carried out in the present embodiment. FIG. 22 is a view showing a printed example of diagnostic inquiry results in the present embodiment.

As shown in FIG. 4, the storage unit 42 of the present embodiment stores the content of the diagnostic inquiries in association with a tree structure. According to the diagnostic inquiry program of the present embodiment, as shown in FIG. 5, the controller 40 displays on the touch panel 34 a screen (situation selection screen 100) by which an inquiry is made concerning the situation (driving operation situation) in which the malfunction symptom occurred. The situation selection screen 100 includes a display (situation inquiry display 102) for making an inquiry concerning the driving operation situation, and selection buttons (situation selection buttons 104a to 104h) for selecting the driving operation situation.

The situation selection buttons 104a to 104h are a first option (choices selected from a first option group). As driving operation situations, there are presented “WHEN STARTING”, “DURING IDLING”, “WHEN SHIFTING”, “WHEN ACCELERATING”, “WHEN CRUISING”, “WHEN TURNING”, “DURING DECELERATION” and “OTHER”. However, the choices for the driving operation situations are not limited to those described above.

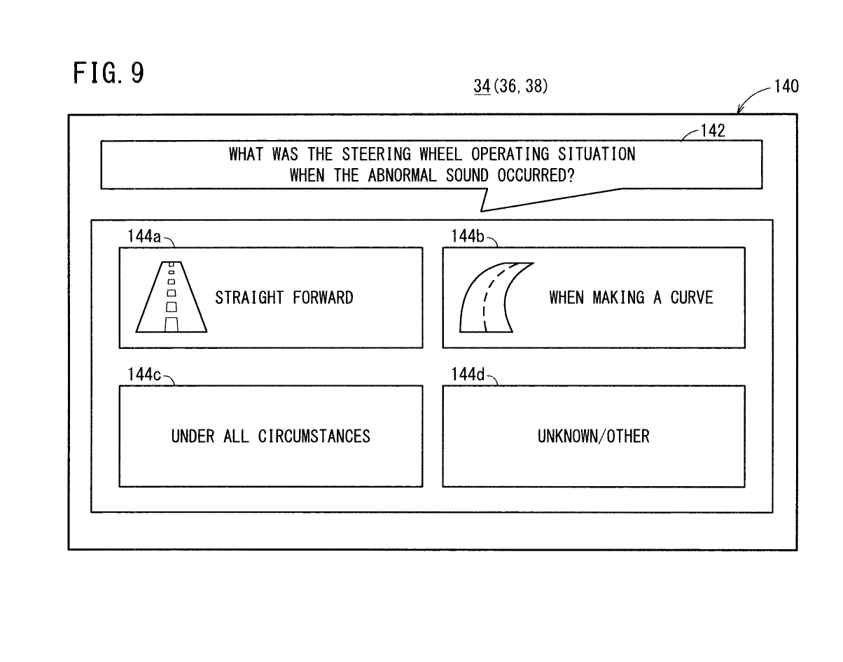

The options shown in FIG. 5 are for driving operation situations in a narrow sense. However, speaking more broadly, the options shown in FIGS. 9, 10 and 17, which will be referred to later, may also be included as content of the driving operation situations.

Below, an example will be described in which “WHEN ACCELERATING” is selected as the driving operation situation. An exemplary list of the content of questions in the case that “WHEN ACCELERATING” is selected is shown in FIG. 22.

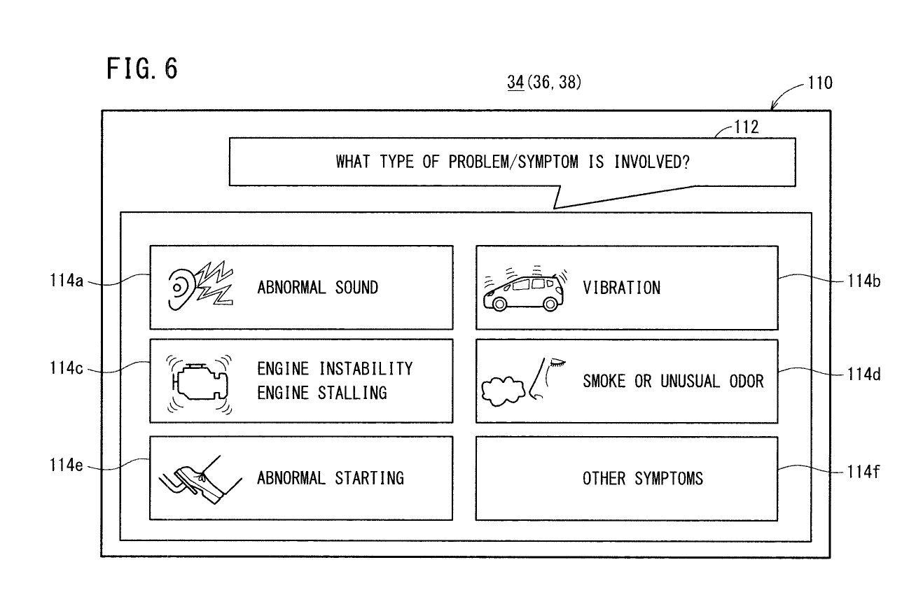

As a diagnostic inquiry given with respect to the customer 300, first it is confirmed what the driving operation situation was when the malfunction symptom occurred. With respect to the question “UNDER WHAT SITUATION DID THE MALFUNCTION SYMPTOM OCCUR?” in the selection screen of FIG. 5, if the answer from the customer 300 is “WHEN ACCELERATING”, then the person in charge of service 302 (user of the diagnostic inquiry device 12) presses the situation selection button 104d to select “WHEN ACCELERATING” as the driving operation situation, whereupon the controller 40 stores such content, while switching the screen to the screen shown in FIG. 6 (malfunction symptom confirmation screen 110) and displaying the same on the touch panel 34. The malfunction symptom confirmation screen 110 is a screen for asking what kind of malfunction symptom has occurred. The screen 110 includes a display (malfunction symptom inquiry display 112) for making an inquiry concerning the content of the malfunction symptom, and selection buttons (symptom selection buttons 114a to 114f) for selecting the content of the malfunction symptom.

The symptom selection buttons 114a to 114f are a second option (choices selected from a second option group). As malfunction symptom content, there are presented “ABNORMAL SOUND”, “vibration”, “ENGINE INSTABILITY, ENGINE STALLING”, “SMOKE OR UNUSUAL ODOR”, “ABNORMAL STARTING” and “OTHER SYMPTOMS”. However, the options for the malfunction symptom content are not limited to those described above.

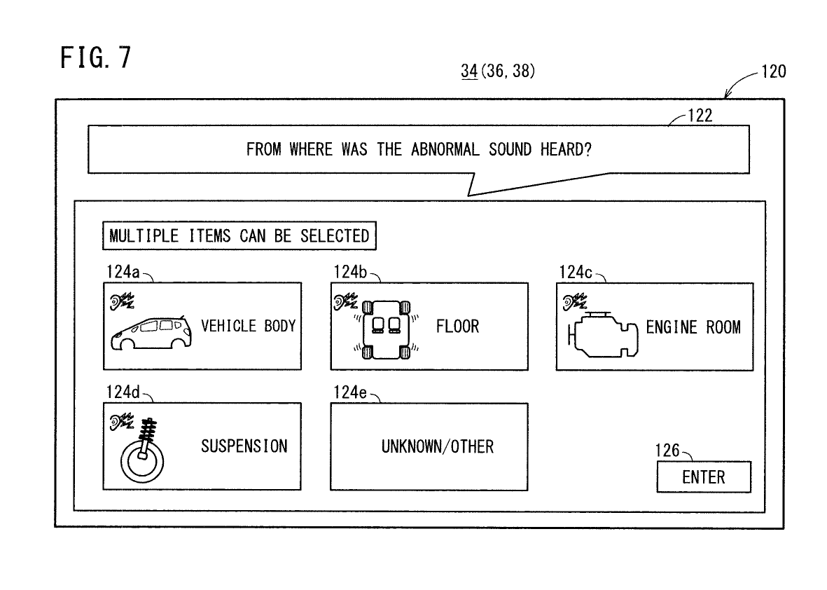

The options shown in FIG. 6 are for malfunction symptoms in a narrow sense. However, speaking more broadly, the options shown in FIGS. 7 through 9 and 11, which will be referred to later, may also be included as content of the malfunction symptoms. Moreover, the options shown in FIG. 9 can be interpreted as content belonging to either one of the driving operation situations or the malfunction symptoms.

If the answer from the customer 300 is “ABNORMAL SOUND”, then the person in charge of service 302 presses the symptom selection button 114a to select “ABNORMAL SOUND” as the malfunction symptom, whereupon the controller stores such content, while switching the screen to the screen shown in FIG. 7 (occurrence location first inquiry screen 120) and displaying the same on the touch panel 34. The occurrence location first inquiry screen 120 is a screen for asking the location of the occurrence of the abnormal sound. The screen 120 includes a display (occurrence location inquiry display 122) for making an inquiry concerning the location of the occurrence of the abnormal sound, selection buttons (abnormal sound occurrence location selection buttons 124a to 124e) for selecting the occurrence location of the abnormal sound, and an “ENTER” button 126.

The abnormal sound occurrence location selection buttons 124a to 124e are a third option (choices selected from a third option group). As abnormal sound occurrence locations, there are presented “VEHICLE BODY”, “FLOOR”, “ENGINE ROOM”, “SUSPENSION”, and “UNKNOWN/OTHER”. However, the options for the sound occurrence locations are not limited to those described above. Further, the buttons 124a to 124e can allow multiple selections to be made. The “ENTER” button 126 is an operation button provided to enable selection of the plurality of buttons 124a to 124e. In the descriptions that follow, a similar enter button is provided with the same goal, for other cases in which plural selectable options are provided.

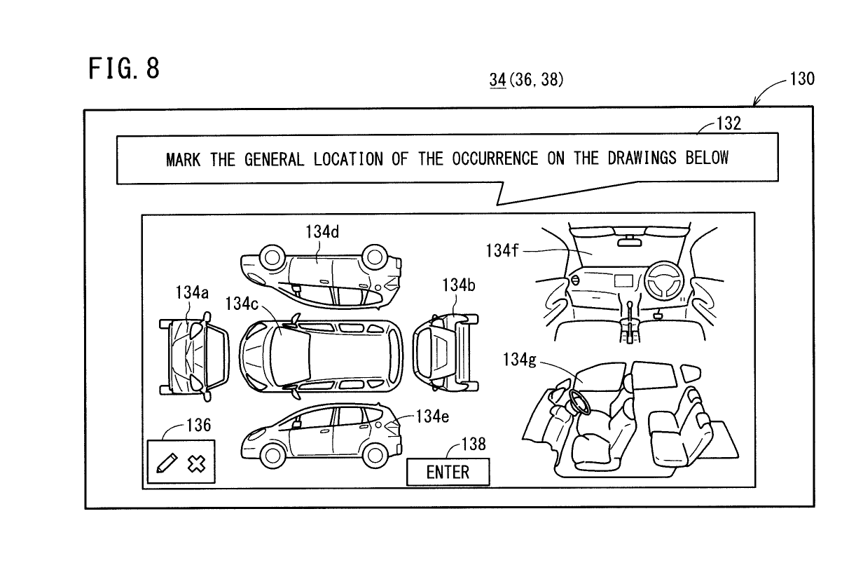

If the answer from the customer 300 is “ENGINE ROOM”, then the person in charge of service 302 selects the selection button 124c and subsequently presses the “ENTER” button 126, whereupon the controller 40 stores such content, while switching the screen to the screen shown in FIG. 8 (occurrence location second inquiry screen 130) and displaying the same on the touch panel 34. Also in the case that plural ones of the buttons 124a to 124e are selected, the controller 40 stores the content thereof, and switches to the display screen shown in FIG. 8 (occurrence location second inquiry screen 130) and displays the same on the touch panel 34. The occurrence location second inquiry screen 130 is a screen that enables markings to be filled in of the abnormal sound occurrence location. The screen 130 includes a display (occurrence location inquiry display 132) for making an inquiry concerning the location of the occurrence of the abnormal sound, vehicle drawings 134a to 134g, a marking erase button 136, and an “ENTER” button 138.

The vehicle drawings 134a to 134g are displays of vehicle drawings 134a to 134g, which are provided to allow a marking to be manually filled in of the abnormal sound occurrence location as a fourth option (choices selected from a fourth option group). As shown in FIG. 8, according to the present embodiment, the vehicle drawings 134a to 134g include a front view (drawing 134a), a rear view (drawing 134b), a plan view (drawing 134c), a left side view (drawing 134d), a right side view (drawing 134e), a view of the vicinity of the driver's seat (drawing 134f), and a perspective view of the cabin interior (drawing 134g) of the vehicle 22. However, the vehicle drawings 134a to 134g are not limited to those described above. Further, at the time that the drawings are displayed, software for a marking tool is automatically initiated along therewith, so as to enable markings to be made on the vehicle drawings 134a to 134g. The marking erase button 136 is a button for initiating a marking eraser tool, which enables the marking displays to be erased and corrected in the vehicle drawings 134a to 134g.

When an abnormal sound occurrence location (estimated position of the abnormal sound generating source) is filled in, based on the response from the customer 300, the person in charge of service 302 performs an operation to surround with a circle the estimated location upon the occurrence of the abnormal sound (see FIG. 22), and thereafter, the person in charge of service 302 presses the “ENTER” button 138. Then, the controller stores such content, while switching the screen to the screen shown in FIG. 9 (steering wheel operating situation confirmation screen 140) and displaying the same on the touch panel 34. The steering wheel operating situation confirmation screen 140 is a screen for making an inquiry regarding the steering wheel operating situation at the time the abnormal sound occurred. The screen 140 includes a display (steering wheel operating situation inquiry display 142) for making an inquiry concerning the steering wheel operating situation, and selection buttons (steering wheel operating situation selection buttons 144a to 144d) for selecting the steering wheel operating situation.

The steering wheel operating situation selection buttons 144a to 144d are a fifth option (choices selected from a fifth option group). As steering wheel operating situations, there are presented “STRAIGHT FORWARD”, “WHEN MAKING A CURVE”, “UNDER ALL CIRCUMSTANCES”, and “UNKNOWN/OTHER”. However, the options for the steering wheel operating situations are not limited to those described above.

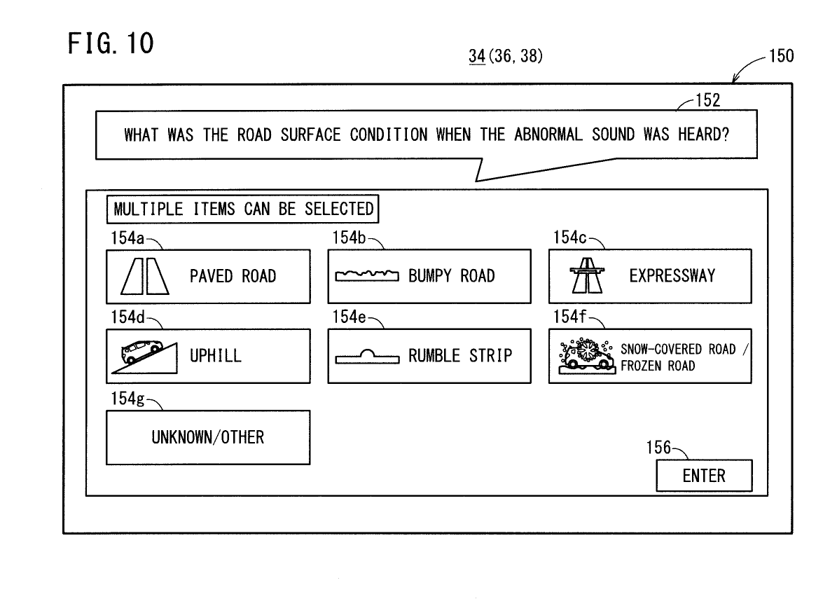

If the answer from the customer 300 is “UNDER ALL CIRCUMSTANCES”, then the person in charge of service 302 presses the selection button 144c, whereupon the controller stores such content, while switching the screen to the screen shown in FIG. 10 (road surface condition confirmation screen 150) and displaying the same on the touch panel 34. Also in the case that any one of the buttons 144a to 144d is selected, similarly the controller stores the corresponding content while switching the screens and displaying the same. The road surface condition confirmation screen 150 is a screen for making an inquiry regarding the road surface condition at the time the abnormal sound occurred. The screen 150 includes a display (road surface condition inquiry display 152) for making an inquiry concerning the road surface condition, selection buttons (road surface condition selection buttons 154a to 154g) for selecting the road surface condition, and an “ENTER” button 156.

The road surface condition selection buttons 154a to 154g are a sixth option (choices selected from a sixth option group). As road surface conditions, there are presented “PAVED ROAD”, “BUMPY ROAD”, “EXPRESSWAY”, “UPHILL”, “RUMBLE STRIP”, “SNOW-COVERED ROAD/FROZEN ROAD”, and “UNKNOWN/OTHER”. However, the options for the road surface condition are not limited to those described above.

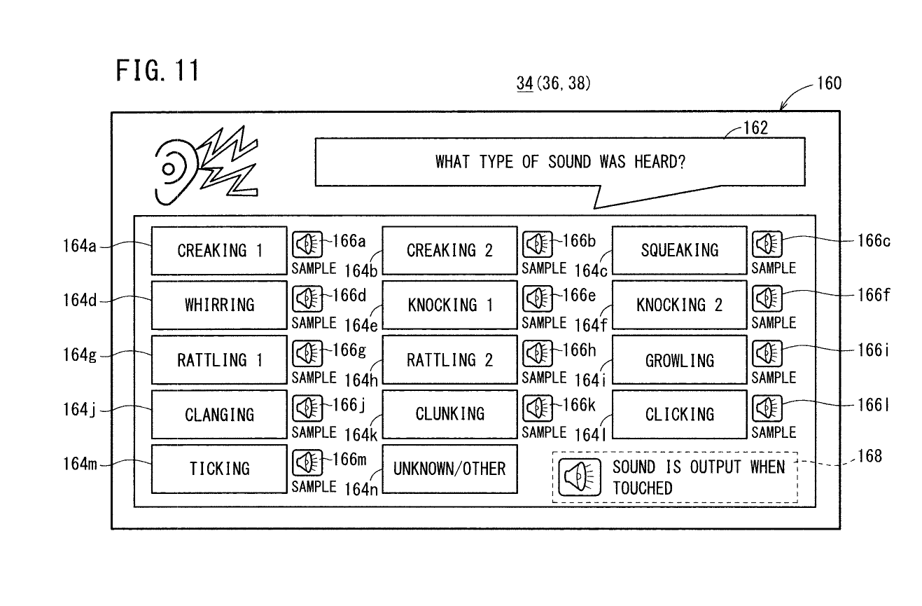

If the answer from the customer 300 is “PAVED ROAD”, then the person in charge of service 302 presses the “ENTER” button 156 after having chosen the selection button 154a, whereupon the controller 40 stores such content, while switching the screen to the screen shown in FIG. 11 (abnormal sound selection screen 160) and displaying the same on the touch panel 34. Also in the case that any one of the buttons 154a to 154g is selected, similarly the controller 40 stores the corresponding content while switching the screens and displaying the same. The abnormal sound selection screen 160 is a screen for inquiring about the type of abnormal sound. The screen 160 includes a display (abnormal sound inquiry display 162) for making an inquiry concerning the type of abnormal sound, selection buttons (abnormal sound selection buttons 164a to 164n) for selecting the type of abnormal sound, sample abnormal sound output buttons 166a to 166m for implementing outputs of samples of the abnormal sounds (sample abnormal sounds), and a display (descriptive display 168) for describing the function of the buttons 166a to 166m.

The abnormal sound selection buttons 164a to 164n are a seventh option (choices selected from a seventh option group). As types of abnormal sounds (onomatopoeic content), there are presented “CREAKING 1”, “CREAKING 2”, “SQUEAKING”, “WHIRRING”, “KNOCKING 1”, “KNOCKING 2”, “RATTLING 1”, “RATTLING 2”, “GROWLING”, “CLANGING”, “CLUNKING”, “CLICKING”, “TICKING”, and “UNKNOWN/OTHER”. However, the options for the types of abnormal sounds are not limited to those described above.

The sample abnormal sound output buttons 166a to 166m are displayed alongside (to the right of) the abnormal sound selection buttons 164a to 164m. The sample abnormal sound output buttons 166a to 166m are buttons that execute the output of samples of the abnormal sounds (sample abnormal sounds) indicative of the corresponding abnormal sound selection buttons 164a to 164m. When any one of the sample abnormal sound output buttons 166a to 166m is pressed, the controller 40 outputs from the speaker 44 a sample abnormal sound corresponding thereto.

Consequently, the customer 300 can compare the output sample abnormal sounds, and judge which sample abnormal sound is near to the abnormal sound that the customer 300 actually heard, and can convey such information to the person in charge of service 302. As a result, the customer 300 and the person in charge of service 302 can select one of the abnormal sound selection buttons 164a to 164n that corresponds most suitably with the actual abnormal sound.

The sample abnormal sounds are items of collected vehicle sounds that are generated corresponding to the respective malfunction symptoms. Stated otherwise, the sample abnormal sound data that are stored in the storage unit 42 are data of collected vehicle sounds that are generated corresponding to the respective malfunction symptoms.

In the descriptive display 168, there is displayed a description to the effect that if any one of the sample abnormal sound output buttons 166a to 166m is touched, then the corresponding sample abnormal sound is output, together with an illustration, which is the same as that displayed in the sample abnormal sound output buttons 166a to 166m.

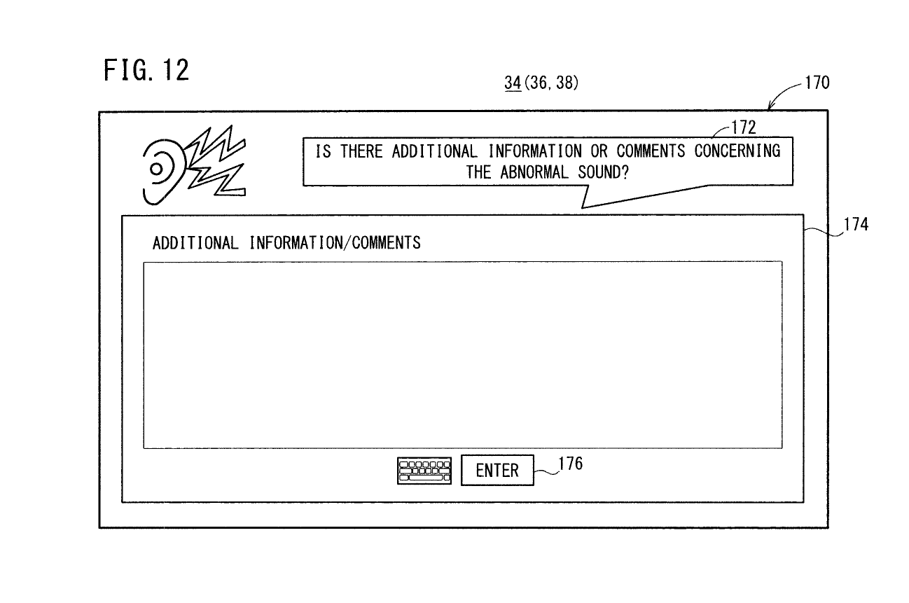

While the person in charge of service 302 presses the sample abnormal sound output buttons 166a to 166m as needed and causes the sample abnormal sounds to be output, the customer 300 is prompted to select a suitable type of abnormal sound that should be selected. In addition, when the person in charge of service 302 presses one of the abnormal sound selection buttons 164a to 164m corresponding to the type of abnormal sound that was selected by the customer 300, the controller 40 stores such content, while switching the screen to the screen shown in FIG. 12 (additional information input screen 170) and displaying the same on the touch panel 34. The additional information input screen 170 is a screen for allowing additional information to be input. The screen 170 includes a display (additional information inquiry display 172) for inquiring whether or not there is additional information, an input field 174 for the additional information, and an “ENTER” button 176.

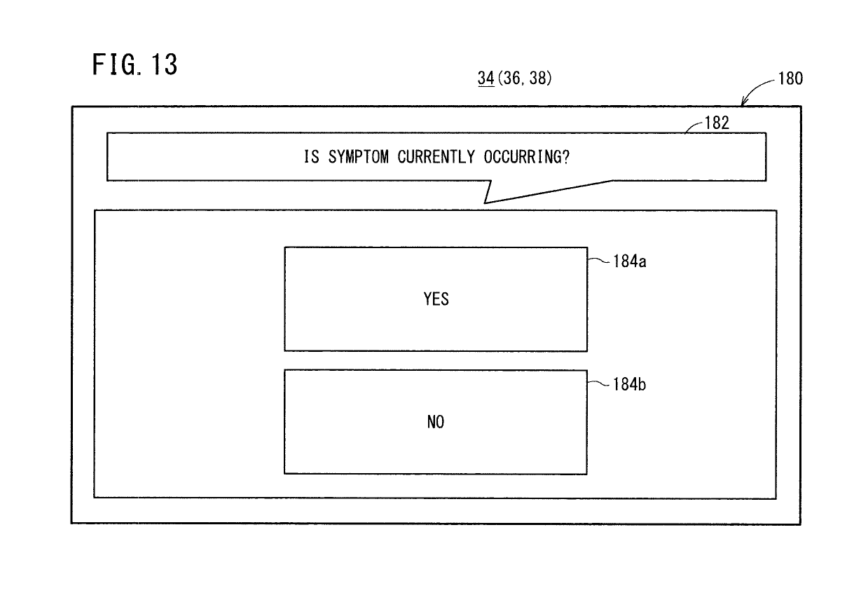

The person in charge of service 302 confirms with the customer 300 whether or not there is any additional information, and as necessary, inputs such additional information into the input field 174. Thereafter, the person in charge of service 302 presses the “ENTER” button 176. Regardless of what kind of input has been made in the input field 174, when the “ENTER” button 176 is pressed, the controller 40 stores the content thereof, and switches the screen to the screen shown in FIG. 13 (current status confirmation screen 180) and displays the same on the touch panel 34. The current status confirmation screen 180 is a screen for making an inquiry regarding whether the malfunction symptom is currently occurring at the present time. The screen 180 includes a display (current status inquiry display 182) for making an inquiry concerning whether or not the malfunction symptom is currently occurring, and selection buttons (current status selection buttons 184a, 184b) for selecting the current status.

The current status selection buttons 184a, 184b are an eighth option (choices selected from an eighth option group). For the current status, the choices “YES” and “NO” are presented.

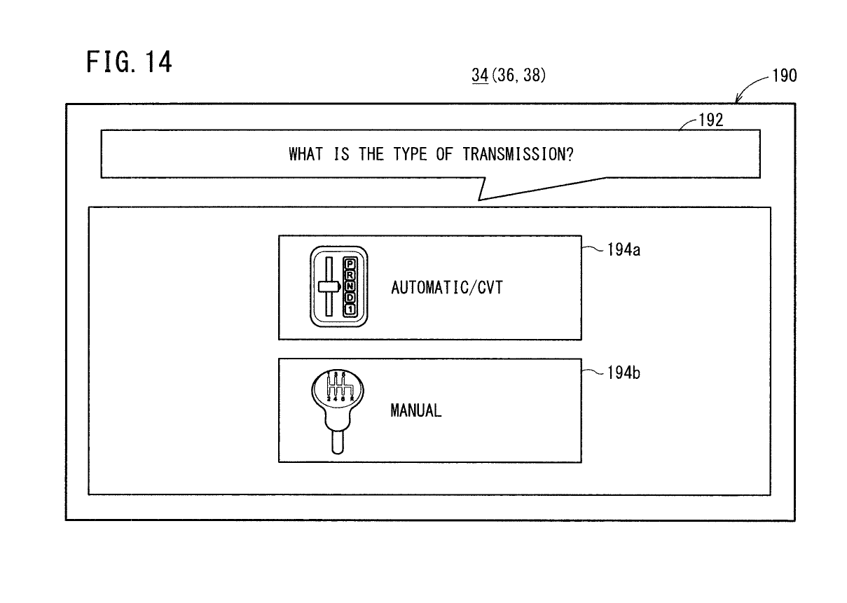

Having confirmed the current status himself or with the customer 300, the person in charge of service 302 selects either one of the current status selection buttons 184a, 184b, whereupon the controller 40 stores such content, while switching the screen to the screen shown in FIG. 14 (TM type confirmation screen 190) and displaying the same on the touch panel 34. The TM type confirmation screen 190 is a screen for inquiring about the type of transmission. The screen 190 includes a display (TM type inquiry confirmation display 192) for making an inquiry concerning the type of transmission, and selection buttons (TM type selection buttons 194a, 194b) for selecting the type of transmission.

The TM type selection buttons 194a, 194b are a ninth option (choices selected from a ninth option group). As types of transmissions, there are presented “AUTOMATIC/CVT” and “MANUAL”. However, the options for the type of transmission are not limited to those described above. Further, information pertaining to this item may be acquired from the vehicle DB 44 by the controller 40 on the basis of the basic information.

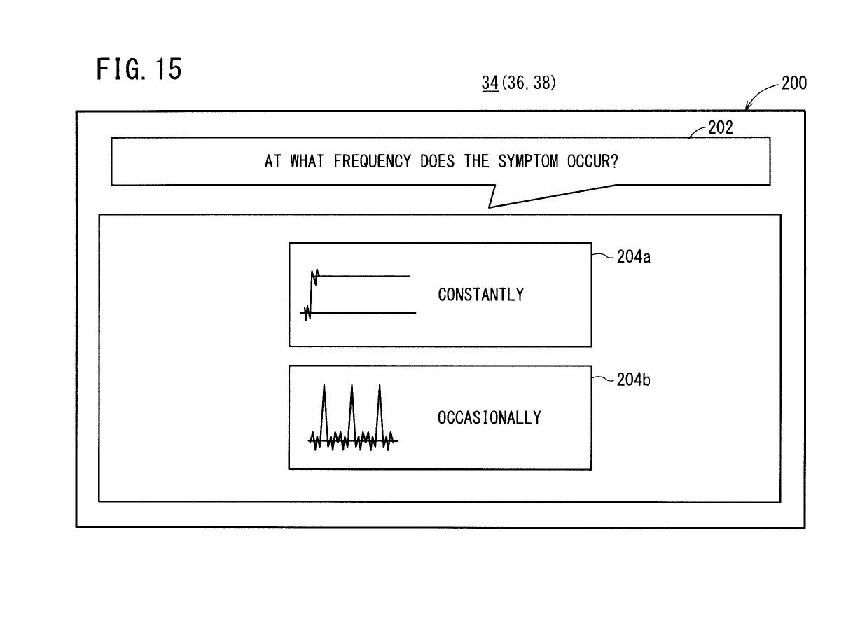

Having confirmed the type of transmission himself or with the customer 300, the person in charge of service 302 selects either one of the buttons 194a, 194b, whereupon the controller 40 stores such content, while switching the screen to the screen shown in FIG. 15 (frequency of occurrence confirmation screen 200) and displaying the same on the touch panel 34. The frequency of occurrence confirmation screen 200 is a screen for inquiring about the frequency of occurrence of the malfunction symptom. The screen 200 includes a display (frequency of occurrence inquiry display 202) for making an inquiry concerning the frequency of occurrence of the malfunction symptom, and selection buttons (frequency of occurrence selection buttons 204a, 204b) for selecting the frequency of occurrence of the malfunction symptom.

The frequency of occurrence selection buttons 204a, 204b are a tenth option (choices selected from a tenth option group). For the frequency of occurrence, the choices “CONSTANTLY” and “OCCASIONALLY” are presented. However, the options for the frequency of occurrence are not limited to those described above.

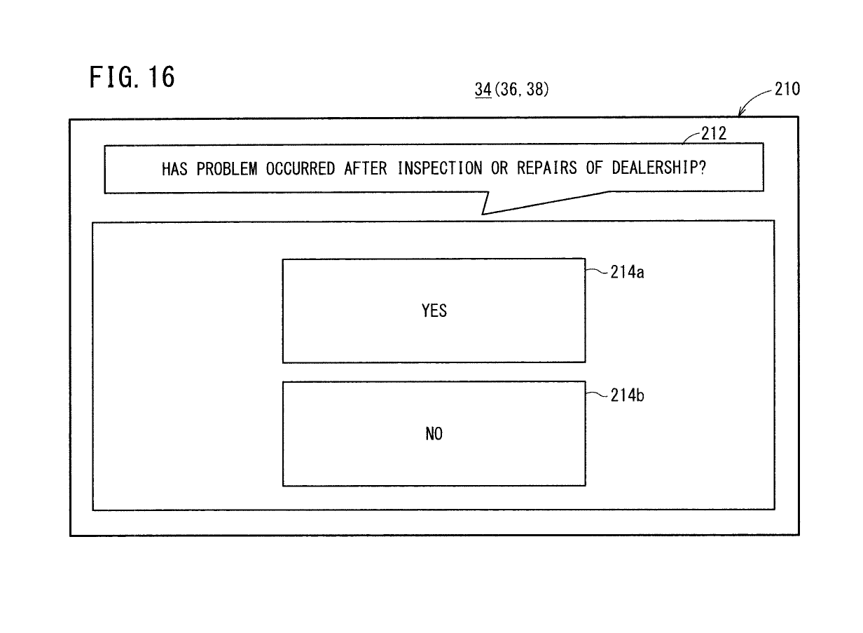

Having confirmed the frequency of occurrence himself or with the customer 300, the person in charge of service 302 selects either one of the buttons 204a, 204b, whereupon the controller 40 stores such content, while switching the screen to the screen shown in FIG. 16 (problem recurrence confirmation screen 210) and displaying the same on the touch panel 34. The problem recurrence confirmation screen 210 is a screen for inquiring about the presence or absence of the occurrence of the problem after the inspection or repair has been performed at the dealership. The screen 210 includes a display (recurrence inquiry display 212) for making an inquiry concerning the presence or absence of recurrence of the problem, and selection buttons (existence of recurrence selection buttons 214a, 214b) for selecting the presence or absence of recurrence of the problem.

The existence of recurrence selection buttons 214a, 214b are an eleventh option (choices selected from an eleventh option group). In relation to the existence of recurrence, the choices “YES” and “NO” are presented.

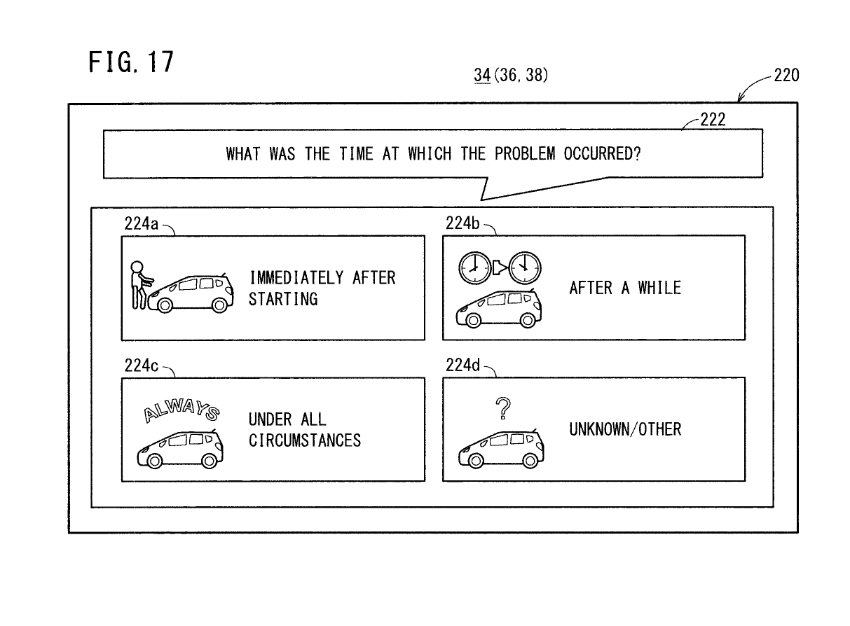

Having confirmed the presence or absence of recurrence with the customer 300, the person in charge of service 302 selects either one of the buttons 214a, 214b, whereupon the controller 40 stores such content, while switching the screen to the screen shown in FIG. 17 (occurrence time confirmation screen 220) and displaying the same on the touch panel 34. The occurrence time confirmation screen 220 is a screen for making an inquiry regarding the time of occurrence of the problem. The screen 220 includes a display (occurrence time confirmation display 222) for making an inquiry concerning the time of occurrence of the problem, and selection buttons (occurrence time confirmation buttons 224a to 224d) for selecting the time of occurrence.

The occurrence time confirmation buttons 224a to 224d are a twelfth option (choices selected from a twelfth option group). As the time of occurrence, there are presented “IMMEDIATELY AFTER STARTING”, “AFTER A WHILE”, “UNDER ALL CIRCUMSTANCES”, and “UNKNOWN/OTHER”. However, the options for the time of occurrence are not limited to those described above.

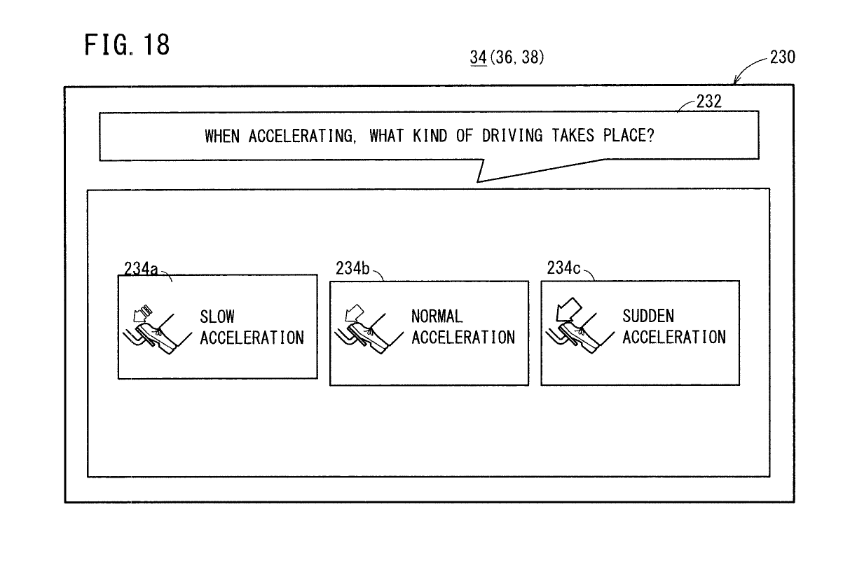

If the answer from the customer 300 is “IMMEDIATELY AFTER STARTING”, then the person in charge of service 302 presses the selection button 224a, whereupon the controller 40 stores such content, while switching the screen to the screen shown in FIG. 18 (acceleration operation confirmation screen 230) and displaying the same on the touch panel 34. Similarly, in the case that any one of the buttons 224a to 224d is selected, the controller 40 stores the corresponding content while switching the screen and displaying the same. The acceleration operation confirmation screen 230 is a screen for inquiring about operation of the accelerator pedal at the time of acceleration. The screen 230 includes a display (acceleration operation inquiry display 232) for making an inquiry concerning operation of the accelerator pedal at the time of acceleration, and selection buttons (acceleration operation selection buttons 234a to 234c) for selecting the operation of the accelerator pedal at the time of acceleration.

The acceleration operation selection buttons 234a to 234c are a thirteenth option (choices selected from a thirteenth option group). For the acceleration pedal operation at the time of acceleration, the choices “SLOW ACCELERATION”, “NORMAL ACCELERATION”, and “SUDDEN ACCELERATION” are presented. However, the options for the accelerator pedal operation at the time of acceleration are not limited to those described above.

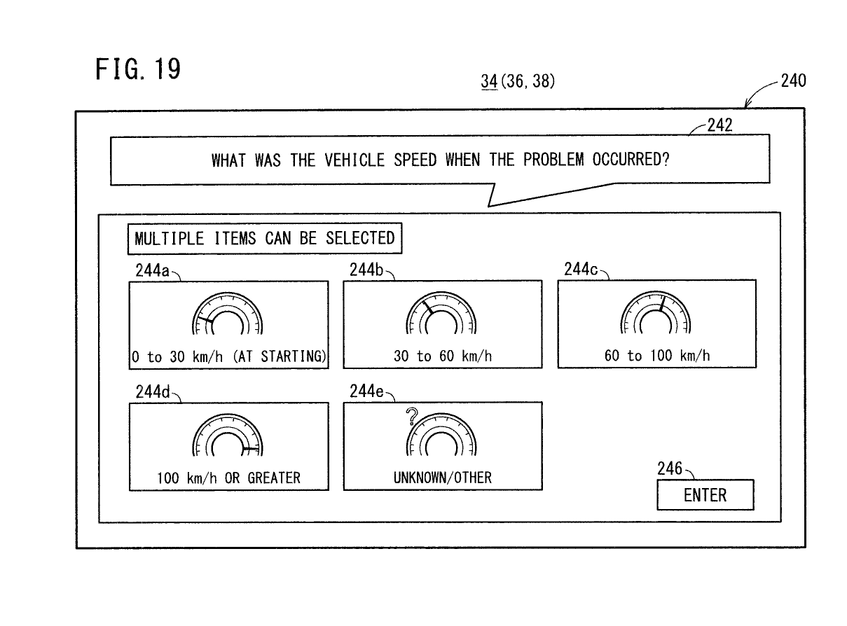

If the answer from the customer 300 is “NORMAL ACCELERATION”, then the person in charge of service 302 presses the selection button 234b, whereupon the controller 40 stores such content, together with switching the screen to the screen shown in FIG. 19 (vehicle speed confirmation screen 240) and displaying the same on the touch panel 34. Also in the case that any one of the buttons 234a to 234d is selected, similarly the controller 40 stores the corresponding content together with switching the screen to be displayed. The vehicle speed confirmation screen 240 is a screen for inquiring about the vehicle speed upon the occurrence of the malfunction symptom. The screen 240 includes a display (vehicle speed inquiry display 242) for making an inquiry concerning the vehicle speed at the time of occurrence of the malfunction symptom, selection buttons (vehicle speed selection buttons 244a to 244e) for selecting the vehicle speed, and an “ENTER” button 246.

The vehicle speed selection buttons 244a to 244e are a fourteenth option (choices selected from a fourteenth option group). For the vehicle speed, there are presented “0 to 30 km/h (AT STARTING)”, “30 to 60 km/h”, “60 to 100 km/h”, “100 km/h OR GREATER”, and “UNKNOWN/OTHER”. However, the options for the vehicle speed are not limited to those described above. Further, the buttons 244a to 244e can allow multiple selections to be made.

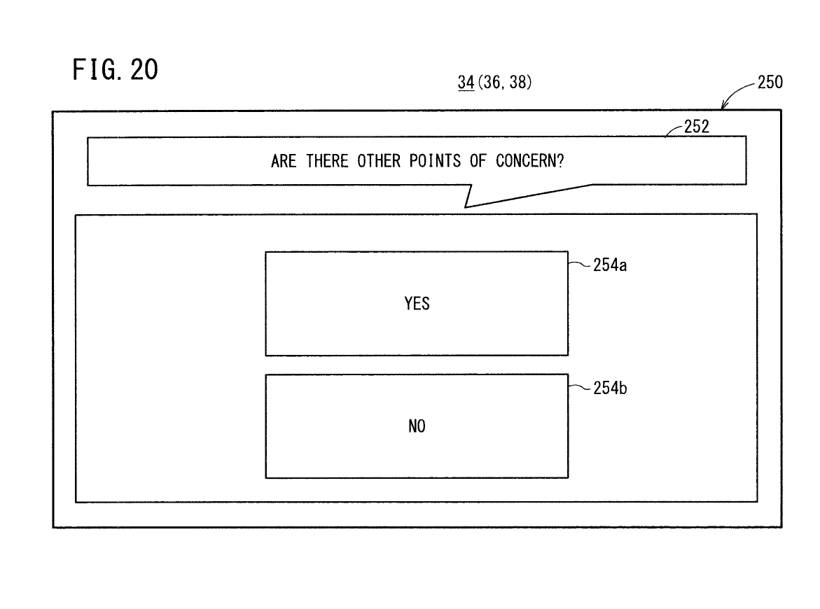

If the answer from the customer 300 is “0 to 30 km/h (AT STARTING)”, then the person in charge of service 302 presses the “ENTER” button 246 after having chosen the selection button 244a, whereupon the controller 40 stores such content, together with switching the screen to the screen shown in FIG. 20 (other confirmation screen 250) and displaying the same on the touch panel 34. Also in the case that plural ones of the buttons 244a to 244e are selected, similarly the controller 40 stores the corresponding content thereof, and switches to the display screen shown in FIG. 20 (other confirmation screen 250) and displays the same on the touch panel 34. The other confirmation screen 250 is a screen for inquiring about the presence or absence of other points of concern. The screen 250 includes a display (points of concern inquiry display 252) for making an inquiry concerning the presence or absence of other points of concern, and selection buttons (other selection buttons 254a, 254b) for selecting the presence or absence of points of concern.

The other selection buttons 254a, 254b are a fifteenth option (choices selected from a fifteenth option group). In relation to the existence of other points of concern, the choices “YES” and “NO” are presented.

Upon confirming with the customer 300, the person in charge of service 302 selects one of the buttons 254a, 254b. If “YES” is selected, the controller 40 stores the content thereof, and switches to a display screen (other input screen (not shown)) for inputting other points of concern and displays the same on the touch panel 34.

If “NO” is selected on the other confirmation screen 250, or if inputting to the other input screen is completed, the controller 40 stores such content, together with switching the screen to the screen shown in FIG. 21 (input confirmation screen 260) and displaying the same on the touch panel 34 (step S17 of FIG. 3). The input confirmation screen 260 includes a diagnostic inquiry results display field 262 for displaying the diagnostic inquiry results, a confirmation button 264, a correction button 266 for carrying out corrections, and a scroll bar 268 for scrolling the display field 262.

Having confirmed the displayed content with the customer 300, when the person in charge of service 302 selects the confirmation button 264, the controller 40 stores all of the diagnostic inquiry results (selection button information) in the storage unit 42 (step S18 of FIG. 3). Further, if the person in charge of service 302 selects the correction button 266, the controller 40 displays a screen (not shown) used for making corrections on the touch panel 34. Then, in response to an operation made by the person in charge of service 302, the controller terminates the diagnostic inquiry program (step S19 of FIG. 3).

Following the diagnostic inquiry, when the person in charge of service 302 notifies the person in charge of maintenance 304 of the diagnostic inquiry results, the person in charge of service 302 permits communications between the diagnostic inquiry device 12 and the printer 14. Additionally, the person in charge of service 302, by operating the diagnostic inquiry device 12, can print out the diagnostic inquiry results from the printer 14, as shown in FIG. 22. Alternatively, the person in charge of service 302, by operating the diagnostic inquiry device 12, may transmit the diagnostic inquiry results by email from the diagnostic inquiry device 12 to the maintenance center terminal 18. At this time, instead of directly transmitting an email from the diagnostic inquiry device 12 to the maintenance center terminal 18, the diagnostic inquiry results can be notified to the maintenance center terminal 18 from the diagnostic inquiry device 12 through the management server 16.

As noted above, although a case has been described in which “WHEN ACCELERATING” is selected as the first option group (see FIG. 5), which is the driving operation situation that is selected initially, and “ABNORMAL SOUND” is selected as the second option group (see FIG. 6), in a case of other options apart therefrom, questions to be made are associated in a tree structure based on a similar concept, and appropriate selections therefrom can be made. In the foregoing manner, the contents of the diagnostic inquiries are associated in a tree structure (see FIG. 4), and thus, in responsive to each of the selection buttons (options), the contents of the questions can be changed to those which are appropriately associated with the selection button.

### 3. Advantages of the Present Embodiment

As noted above, according to the present embodiment, since selection of driving operation situations in which malfunction symptoms occur is used as inquiry items (see FIG. 5), an inquiry scheme to which the customer 300 easily responds can be provided.

Further, after a driving operation situation in which the malfunction symptom occurs has been selected, the selection of content for the malfunction symptom, which is associated with the selected driving operation situation, is requested (e.g., refer to the relationship between FIGS. 5 and 6). For this reason, it is possible to narrow down the content for the malfunction symptom responsive to the driving operation situation, and the number of necessary inquiry items can be reduced.

Furthermore, in the event that the content of the malfunction symptom is associated with the occurrence of an abnormal sound, a corresponding sample abnormal sound can be output as an indicator for selecting the symptom (see FIG. 11). Therefore, a person who has actually heard an abnormal sound can compare the abnormal sound with a plurality of sample abnormal sounds, whereby the person can easily select and respond to the symptom content of an abnormal sound occurrence that may be difficult to express verbally.

In the present embodiment, the sample abnormal sound data is data for which vehicle sounds are collected, and wherein the vehicle sounds are generated responsive to the respective malfunction symptoms. Consequently, since actual vehicle sounds are compared with respect to the abnormal sound, confirmation of the content of the malfunction symptom is easily carried out, based on slight differences in the abnormal sounds for which judgment may be difficult.

According to the present embodiment, in the case that a malfunction symptom in which an abnormal sound is generated has been selected by the selection buttons 164a to 164n, the controller 40 displays, on the display unit 38 of the touch panel 34, vehicle drawings 134a to 134g on which an estimated location of the generating source of the abnormal sound can be input by an operation input (selection input) made by the person in charge of service 302 (user of the diagnostic inquiry device 12) (see FIG. 8), and accepts the operation input from the person in charge of service 302 as the estimated location of the abnormal sound generating source. Thus, the person in charge of service 302 or the customer 300 can select or input the estimated position intuitively and as one actually felt.

In the present embodiment, the storage unit 42 associates and stores in a tree structure (see FIG. 4) the situation selection buttons 104a to 104h (see FIG. 5), the symptom selection buttons 114a to 114f (see FIG. 6), and the abnormal sound selection buttons 164a to 164n (see FIG. 11), and the controller 40 switches screens for each of the situation selection buttons 104a to 104h, the symptom selection buttons 114a to 114f, and the abnormal sound selection buttons 164a to 164n, and displays the corresponding screens on the display unit 38 of the touch panel 34 (see FIGS. 5, 6, and 11).

According to this feature, by associating the situation selection buttons 104a to 104h, the symptom selection buttons 114a to 114f, and the abnormal sound selection buttons 164a to 164n in a tree structure, the content of the questions can be organized systematically, and the ordering of the questions can be presented in a natural and easily understood manner. Therefore, for the customer 300 to whom diagnostic inquiries are made, content that the customer 300 wants to convey can be conveyed adequately, and the customer's satisfaction can be enhanced.

According to the present embodiment, the controller 40 displays the situation selection buttons 104a to 104h, the symptom selection buttons 114a to 114f, the abnormal sound selection buttons 164a to 164n, etc., in the form of illustrations on the touch panel 34 (see FIGS. 5, 6, 11, etc.). Consequently, the operation screen is easily viewed, and through the displayed illustrations, grasping of the inquiry content and the operation to select such inquiry content can be simplified.

### B. Modifications

The present invention is not limited to the above embodiment. It is a matter of course that various additional or modified arrangements can be adopted based on the disclosed content of the present specification. For example, the following configurations can be adopted.

### 1. Subject for Diagnosis

With the above-described embodiment, although the diagnostic inquiry device 12 is utilized in an automotive vehicle 22, for example, insofar as attention is focused on the functions of the diagnostic inquiry device 12, the diagnostic inquiry device 12 can be used in other apparatus apart from automotive vehicles 22 (for example, vehicles such as ships, aircraft, and the like, robots, manufacturing equipment, household power systems, or home appliances).

### 2. Configuration of Diagnostic Inquiry Device 12

According to the above embodiment, the diagnostic inquiry program and the sample abnormal sound data used by the diagnostic inquiry device 12 are stored in advance in the storage unit 42 of the diagnostic inquiry device 12. However, the present invention is not limited to this feature. Alternatively, the diagnostic inquiry program and the sample abnormal sound data may be downloaded from an external source (e.g., the server 16), or without being downloaded, may be executed as a program and data provided by an application service provider (ASP).

In the above embodiment, an example was indicated in which the diagnostic inquiry device 12 outputs (prints) the diagnostic inquiry results, and the person in charge of maintenance 304 analyzes the cause of the malfunction. However, the diagnostic inquiry device 12 may carry out a process to analyze the cause (or estimate the cause) based on the diagnostic inquiry results. Alternatively, analysis of the cause can be carried out in the server 16. In this case, the diagnostic inquiry results are transmitted to the server 16 from the diagnostic inquiry device 12, and the server 16 reads out from its own database one or multiple causes responsive to the received diagnostic inquiry results, and sends the one or multiple causes to the diagnostic inquiry device 12. In addition, the diagnostic inquiry device 12 may output the causes received from the server 16 through the display unit 38 or the like. Regarding this point (using the server 16 for analyzing the cause), for example, the same configuration and processes disclosed in U.S. Patent Application Publication No. 2003/0225790A1 may be used.

### 3. Diagnostic Inquiry Process

With the above-described embodiment, although the respective options are selected using the selection buttons (see FIGS. 5 to 21), the options can be selected on the screen using a method other than selection buttons (e.g., check boxes).

According to the present embodiment, although the controller 40 switches screens for each of the situation selection buttons 104a to 104h, the symptom selection buttons 114a to 114f, and the abnormal sound selection buttons 164a to 164n, and displays the screens on the display unit 38 (see FIGS. 5, 6, and 11), when considered from another standpoint (e.g., the standpoint of using the sample abnormal sounds), one or two of the sets of selection buttons may be displayed on the same screen.

In the above-described embodiment, the symptom selection buttons 114a to 114f and the vehicle drawings 134a to 134g are displayed on different screens (see FIG. 8). However, the vehicle drawings 134a to 134g may be displayed on the same screen as the symptom selection buttons 114a to 114f.

In the above-described embodiment, although the sample abnormal sound data is made up of data of collection of vehicle sounds that are generated corresponding to the respective malfunction symptoms, other sounds (e.g., synthetic sounds) may be used.

1. A diagnostic inquiry device for carrying out a diagnostic inquiry in order to acquire related information related to a malfunction symptom that occurs in a diagnostic target vehicle, and for, based on the acquired information, estimating a cause of the malfunction symptom on its own or externally outputting the acquired information, the diagnostic inquiry device comprising:
a display unit configured to display questions for acquiring the related information;
a sample abnormal sound outputting unit configured to output sample abnormal sounds corresponding to malfunction symptoms;
a controller configured to control display of the display unit and output of sounds from the sample abnormal sound outputting unit, and process an operation input from a user; and
a storage unit configured to store display data and sample abnormal sound data, the display data being data related to displays of the display unit, the sample abnormal sound data being data related to the sample abnormal sounds;
wherein the controller:
displays on the display unit a plurality of situation selection buttons and a plurality of symptom selection buttons, the situation selection buttons being selection buttons for determining selection of a driving operation situation in which the malfunction symptom occurs, the symptom selection buttons being selection buttons for determining selection of content of the malfunction symptom, the content being associated with selection result of the situation selection buttons; and
in a case that the content of the malfunction symptom relates to abnormal sounds generated by the diagnostic target vehicle, displays the symptom selection buttons and sample abnormal sound output buttons in pairs on the display unit, the symptom selection buttons being arranged alongside for comparison, the sample abnormal sound output buttons causing the sample abnormal sounds corresponding to the malfunction symptom to be output.

2. The diagnostic inquiry device according to claim 1, wherein the sample abnormal sound data is data for which vehicle sounds are collected, the vehicle sounds being generated responsive to the respective malfunction symptoms.

3. The diagnostic inquiry device according to claim 1, wherein the controller:
in a case that a malfunction symptom in which the abnormal sound is generated has been selected by the symptom selection buttons, displays vehicle drawings on the display unit, wherein an estimated location of a generating source of the abnormal sound can be input on the vehicle drawings by an operation input from the user; and
accepts the operation input from the user as the estimated location of the generating source of the abnormal sound.

4. The diagnostic inquiry device according to claim 1, wherein:
the storage unit associates and stores in a tree structure the situation selection buttons and the symptom selection buttons; and
the controller switches screens for each of the situation selection buttons and the symptom selection buttons and displays the screens on the display unit.

5. The diagnostic inquiry device according to claim 1, wherein the controller displays the situation selection buttons, the symptom selection buttons, and the sample abnormal sound output buttons in form of illustrations on a touch panel.

6. A diagnostic inquiry method for confirming, with a customer, a malfunction symptom of a diagnostic target vehicle through a diagnostic inquiry, comprising the steps of:
displaying on a display unit a plurality of situation selection buttons and a plurality of symptom selection buttons, the situation selection buttons being selection buttons for determining selection of a driving operation situation in which the malfunction symptom occurs, the symptom selection buttons being selection buttons for determining selection of content of the malfunction symptom, the content being associated with selection result of the situation selection buttons; and
in a case that the content of the malfunction symptom relates to an abnormal sound generated by the diagnostic target vehicle, displaying the symptom selection buttons and sample abnormal sound output buttons in pairs on the display unit, the symptom selection buttons being arranged alongside for comparison, the sample abnormal sound output buttons causing sample abnormal sounds corresponding to the malfunction symptom to be output.

7. A diagnostic inquiry device for carrying out a diagnostic inquiry in order to acquire related information related to an abnormal event that occurs in a diagnostic target device, and for, based on the acquired information, estimating a cause of the abnormal event on its own or externally outputting the acquired information, the diagnostic inquiry device comprising:
an option presentation unit configured to present, as images, options for acquiring the related information;
a sample abnormal sound outputting unit configured to output sample abnormal sounds corresponding to abnormal events; and
a controller configured to control presentation of the options by the option presentation unit and output of sounds from the sample abnormal sound outputting unit, and process a selection input from a user;
wherein the controller, in a case that content of the abnormal event relates to an abnormal sound generated by the diagnostic target device, displays operation buttons for the options corresponding to the content of the abnormal event, the operation buttons being arranged alongside for comparison, and outputs the sample abnormal sounds from the sample abnormal sound outputting unit, responsive to a selection input of the options, the sample abnormal sounds being based on multiple types of sample abnormal sound data that are stored in an external server or in a storage unit of the diagnostic inquiry device.
